(19) United States
(12) Patent Application Publication
(10) Pub. No.: US 2025/0206281 A1
(43) Pub. Date: Jun. 26, 2025

(54) METHOD FOR OPERATING A BRAKING SYSTEM, CONTROL UNIT AND BRAKING SYSTEM

(71) Applicant: Robert Bosch GmbH, Stuttgart (DE)

(72) Inventors: Thadathil Mohamed Shareef, Abstadt (DE); Bertram Foitzik, Ilsfeld (DE); Otmar Bussmann, Abstatt (DE)

(21) Appl. No.: 18/913,608

(22) Filed: Oct. 11, 2024

(30) Foreign Application Priority Data
Dec. 20, 2023 (DE) 10 2023 213 033.5

(51) Int. Cl. B60T 13/66; B60T 13/16; B60T 13/18; B60T 13/62; B60T 17/22

(52) U.S. Cl. CPC B60T 13/662; B60T 13/18; B60T 17/22; B60T 13/161; B60T 13/62; B60T 2220/04; B60T 2270/402

(57) ABSTRACT

A method for operating a braking system for a motor vehicle. The braking system includes at least one hydraulically actuatable wheel brake, a controllable pressure-generating device for providing a hydraulic pressure in a brake circuit including the at least one wheel brake, and an actuating element that is actuatable by a driver and is intended for specifying a braking request. The brake circuit is assigned a sensor for detecting an actual hydraulic pressure in the brake circuit. The pressure-generating device is controlled depending on the braking request and the actual hydraulic pressure detected in the brake circuit by the sensor. An efficiency value of the pressure-generating device is ascertained and stored depending on the braking request and the detected actual pressure. In the event of a function error of the sensor, the pressure-generating device is controlled at least depending on the braking request and the stored efficiency value.

### CROSS REFERENCE

The present application claims the benefit under 35 U.S.C. § 119 of German Patent Application No. DE 10 2023 213 033.5 filed on Dec. 20, 2023, which is expressly incorporated herein by reference in its entirety.

### FIELD

The present invention relates to a method for operating a braking system for a motor vehicle, wherein the braking system comprises at least one hydraulically actuatable wheel brake, at least one controllable pressure-generating device for providing a hydraulic pressure in a brake circuit comprising the at least one wheel brake, and at least one actuating element that is actuatable by a user and is intended for specifying a braking request, wherein the brake circuit is assigned at least one sensor for detecting an actual hydraulic pressure in the brake circuit, and wherein the pressure-generating device is controlled depending on the braking request and an actual pressure detected in the brake circuit by the sensor.

Furthermore, the present invention relates to a control unit specifically configured to perform the aforementioned method when used as intended.

Furthermore, the present invention relates to a braking system for a motor vehicle as described above, with the aforementioned control unit.

### BACKGROUND INFORMATION

With the electrification of motor vehicles, the number of and desire for electrified braking systems is also increasing, which are in particular designed as so-called brake-by-wire systems and no longer require a mechanical connection between a brake pedal and the brake circuit or the wheel brake. In such systems, a pressure-generating device is generally used, which can be driven by an electric motor and is controlled depending on a detected braking request in order to provide a hydraulic pressure necessary to implement the requested braking force in a brake circuit comprising at least one wheel brake. Such a pressure-generating device often comprises a controllable electric motor, which is operatively connected to a piston pump, which comprises a hydraulic piston displaceable in a hydraulic cylinder. By displacing the hydraulic piston, hydraulic volume is pushed into the brake circuit, thereby increasing the hydraulic pressure in the brake circuit. The volume displacement or the pressure increase depends on the effective area of the hydraulic piston as well as on the movement path of the hydraulic piston and the force with which the hydraulic piston is displaced in the cylinder. The pressure generated in the brake circuit is monitored by means of a sensor in order to regulate the control of the pressure-generating device in such a way that the actual pressure generated corresponds as precisely as possible to the desired hydraulic pressure resulting from the braking request.

If the information detected by the sensor is not available, for example because the sensor has a function error, it is conventional to allow the actuating element to mechanically intervene in the brake circuit as a fallback level. For this purpose, the brake pedal in conventional solutions is hydraulically coupled directly to the brake circuit so that the user or driver of the motor vehicle can generate a hydraulic pressure directly in the brake circuit by actuating the brake pedal. Since braking force boosting otherwise provided by the pressure-generating device is not available in this case, the failure of the pressure sensor and the switch to the mechanical fallback level are immediately noticeable to the driver.

### SUMMARY

A method according to the present invention may have an advantage that, in the event of a failure or a function error of the sensor, it is not necessary to immediately switch to the mechanical fallback level and braking force assistance can continue to be maintained. According to an example embodiment of the present invention, it is provided for this purpose that, when the pressure sensor in particular is still fully functional or operating without errors, an efficiency value of the pressure-generating device is ascertained depending on the braking request and the detected actual hydraulic pressure and stored, and that, in the event of a function error of the sensor, the pressure-generating device is controlled at least depending on the braking request and the stored efficiency value. As long as the sensor does not malfunction, an efficiency value, which results in particular from the relationship between a particular braking request and the resulting hydraulic pressure detected by the sensor, is thus ascertained during ongoing operation of the braking system. The efficiency value takes into account changes, in particular of the pressure-generating device, which may occur over time, for example due to wear. For example, the efficiency of the pressure-generating device decreases over time because, for example, the tightness of the piston pump deteriorates or because the mechanics of a gearing mechanism that is interposed between the electric motor and the piston pump gives way due to wear or has increased play. Through the efficiency value, it is thus taken into account that the behavior of the pressure-generating device can change, in particular with increasing age. By taking the efficiency value into account when controlling the pressure-generating device, this change can thus be compensated for and the hydraulic pressure in the brake circuit can be set sufficiently precisely even without the values of the pressure sensor. In the event of a function error of the sensor, the pressure regulation, which is usually made possible by the sensor, is thus at least largely compensated for by taking the efficiency value into account. This makes it possible for the braking system to continue to operate even without knowing the actual pressure, so that the driver still has braking force boosting available. In particular, this makes it possible to gradually or smoothly switch to a mechanical fallback level, which allows the driver to continue to use braking force boosting for at least a certain period of time. In addition, this also takes into account other boundary conditions that are important for the efficiency of the pressure-generating device, such as the temperature of the pressure-generating device or of the hydraulic medium in the brake circuit, the age of the components of the braking system, or a gearing mechanism hysteresis of a gearing mechanism connecting the electric motor to the piston pump. Preferably, the efficiency value is therefore determined depending on a current temperature, an age of the braking system, in particular of the pressure-generating device, a gearing mechanism hysteresis and/or a detected actual pressure of the sensor. In this way, one or more characteristic curves and/or characteristic maps are in particular generated, which are advantageously used in the event of a failure of the sensor or a malfunction of the sensor in order to select the efficiency value matching the current operating condition, for example depending on a current temperature.

According to an example embodiment of the present invention, preferably, the efficiency value is recorded and stored regularly, in particular at specified intervals or with each braking request. This ensures that, if the sensor fails, a relatively current efficiency value is available, which can be used to continue to operate the braking system.

According to an example embodiment of the present invention, preferably, the pressure-generating device comprises a controllable electric motor and a hydraulic piston that is drivable by the electric motor and is intended for generating hydraulic pressure, wherein the electric motor is coupled to the hydraulic piston by the gearing mechanism, and wherein an efficiency value of the gearing mechanism is ascertained as the efficiency value. In this respect, the pressure-generating device is in particular an electromotive piston pump. Since the gearing mechanism in particular has, for example, different efficiencies at different temperatures, which can result, for example, from temperature-related changes in the size of components of the gearing mechanism, its efficiency is of great importance for the hydraulic pressure in the brake circuit. The hydraulic pressure generated can thus increase or decrease with changing temperatures while the control of the electric motor remains the same. While this effect is normally detected by the sensor and corrected by controlling the pressure-generating device, in the event of a sensor failure, this effect is now at least partially compensated for by the present method by knowing the efficiency value.

Furthermore, according to an example embodiment of the present invention, it is preferably provided that a current pressure value of the hydraulic medium in the brake circuit is estimated depending on an actual torque of the electric motor, an effective hydraulic area of the piston pump, in particular of a hydraulic piston of the piston pump, and the efficiency value. The estimated pressure value also makes possible the above-described advantageous regulation of the pressure-generating device, which leads to a behavior of the braking system that is familiar to the driver. Knowing the actual torque and the effective hydraulic area of the hydraulic piston, the theoretical contribution of the pressure-generating device to the hydraulic pressure in the brake circuit can be determined. By taking the efficiency value into account, this contribution is advantageously corrected in order to optimize the control of the pressure-generating device in order to compensate for temperature influences, aging phenomena or the like.

Preferably, according to an example embodiment of the present invention, the pressure value is estimated depending on a gear ratio of the gearing mechanism of the pressure-generating device and a direction of movement of the electric motor. If the gearing mechanism has a gear ratio, this gear ratio is advantageously also taken into account. Taking the direction of movement into account ensures that the efficiency of the gearing mechanism is optimally taken into account, because it can vary depending on the direction of movement or the direction of action of the electric motor.

According to a preferred development of the present invention, the pressure-generating device is controlled depending on the braking request and the estimated pressure value in order to maintain optimal operation of the braking system in the event of a sensor failure. Preferably, the braking system is only switched to the mechanical fallback level (if possible) after a specified time has elapsed, in order to avoid the last-stored efficiency value being so far in the past that it can no longer ensure optimal continued operation of the braking system, for example because the ambient temperature or the brake circuit temperature has changed beyond a specified limit value since the last-recorded efficiency value. Particularly preferably, if the sensor fails or a malfunction of the sensor is detected, the driver is also given a warning message so that they can visit a workshop promptly to have the braking system repaired.

Preferably, according to an example embodiment of the present invention, the estimated pressure value is compared to the pressure value detected by the pressure sensor. This makes it possible to detect, for example, a function error of the pressure sensor. Particularly preferably, in normal operation, i.e., when the pressure sensor is working without errors, the efficiency value is ascertained or corrected on the basis of the aforementioned comparison so that the efficiency value is learned on the basis of the estimated pressure. If a malfunction of the pressure sensor occurs, switching preferably takes place from the measured pressure value to the estimated pressure value. Since the efficiency value has already been learned on the basis of the estimated pressure value, it is easy to switch between the measured and the estimated pressure value. This has the advantageous result, among others, that the pressure regulator already present in the system can be retained.

According to a preferred development of the present invention, a target torque depending on the braking request and the efficiency value is specified to the electric motor, wherein a brake boost is taken into account so that the malfunction of the sensor is at least not immediately noticeable to the driver.

The control unit according to the present invention is specifically configured to perform the method according to the present invention when used as intended. This results in the advantages already mentioned above.

The braking system according to the present invention includes the control unit according to the present invention. This results in the advantages already mentioned above.

The present invention is explained in more detail below with reference to the figures.

### BRIEF DESCRIPTION OF THE DRAWINGS

FIG. 1 shows an advantageous braking system for a motor vehicle in a simplified representation, according to an example embodiment of the present invention.

FIG. 2 shows a flowchart for explaining an advantageous method for operating the braking system according to the present invention

FIG. 3 is a schematic overview of the advantageous example method according to the present invention.

### DETAILED DESCRIPTION OF EXAMPLE EMBODIMENTS

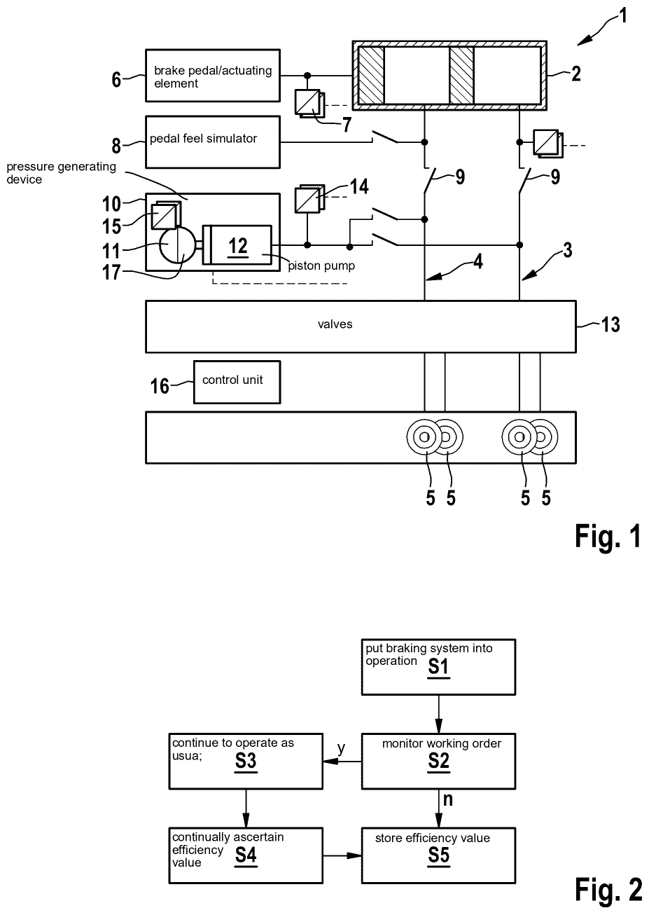

FIG. 1 shows a simplified representation of an advantageous braking system 1 for a motor vehicle not shown in detail here. The braking system 1 comprises a master brake cylinder 2, which here is designed as a tandem cylinder and is hydraulically connected to two brake circuits 3, 4 of the braking system 1. Each brake circuit 3, 4 comprises at least one, here two, wheel brakes 5, which are hydraulically actuable. The wheel brakes 5 are designed as friction brakes.

Assigned to the master brake cylinder 2 is an actuating element 6, which can be actuated by a driver of the motor vehicle, here in the form of a brake pedal, which is mechanically coupled to a piston, in particular a tandem piston, of the master brake cylinder 2. The brake pedal 6 is assigned a sensor 7, which monitors the actuation of the actuating element 6, in particular an actuating path, an actuating speed and/or an actuating force. The master brake cylinder 2 is furthermore connected to a pedal feel simulator 8, into which hydraulic volume displaced from the master brake cylinder 2 by actuation of the brake pedal can be introduced so that the driver receives a reproducible and pleasant brake pedal feel, although the wheel brakes 5 are hydraulically/mechanically decoupled from the brake pedal 6. For this purpose, a controllable separating valve 9 is provided between the master brake cylinder 2 and the wheel brakes in each brake circuit 3, 4, which separating valve is interposed between the pedal feel simulator 8 and the wheel brakes 5. If the separating valve 9 is opened, the hydraulic volume from the master brake cylinder 2 is conducted directly into the pedal feel simulator 8.

Furthermore, the braking system 1 comprises a pressure-generating device 10 comprising an electric motor 11, which is in particular connected by a gearing mechanism 17 to a hydraulic pump, which is designed as a piston pump 12 here. The gearing mechanism 17 in particular has an advantageous gear ratio for the operation of the piston pump. The pressure-generating device 10 and connected to the wheel brakes 5 and the corresponding separating valve 9 via the brake circuits 3, 4. If the electric motor 10 is activated, it drives the hydraulic pump, whereby hydraulic volume is pushed into each brake circuit 3, 4 and a corresponding hydraulic pressure is generated there, which can be used to actuate the wheel brakes 5. Through the inlet and outlet valves (shown in FIG. 1 in a simplified manner by a block 13) assigned to the wheel brakes 5, the available actual hydraulic pressure is distributed purposefully to the individual wheel brakes 5 in order to implement the braking request on the one hand and, for example, to implement driving safety functions, such as an ABS or ESP function of the braking system, on the other hand.

The braking system 1 furthermore comprises a sensor 14, in particular a pressure sensor, for detecting or monitoring the hydraulic pressure p_{actual} provided by the pressure-generating device 10. In addition, the electric motor 11 is assigned a current sensor 15, by means of which the operating current of the electric motor 11 can be monitored.

A control unit 16 monitors/records the sensor values and controls the pressure-generating device 10 and the valves (block 13). The control unit 16 is designed to perform the method described below.

During normal operation of the braking system 1, actuating the actuating element 6 generates a braking request, which is recorded by the control unit 16. Normally, the separating valves 9 are open so that the actuation of the brake pedal only leads to hydraulic volume being pushed from the master brake cylinder 2 into the pedal feel simulator 8 but not into the brake circuits 3, 4. Rather, depending on the detected braking request, the control unit 16 controls the pressure-generating device 10 to generate, in the brake circuits 3, 4, a hydraulic target pressure p_{target} necessary to implement the braking request, which pressure is then made available to the selected wheel brakes 5 by controlling the valves (block 13) in order to ensure the desired deceleration. The control unit 16 is designed to implement braking force assistance or boosting, whereby the hydraulic pressure made available in the brake circuits 3, 4 is significantly greater than the hydraulic pressure generated in the master brake cylinder 2 by the driver.

Until now, if the sensor 14 failed or the information or signals provided by the sensor 14 were not available, the separating valves 9 would have been closed so that, through actuating the actuating element 6, the driver could mechanically generate the hydraulic pressure, generated in the master brake cylinder 2, directly in each brake circuit and exert it on the wheel brakes 5. However, in this case, the braking force assistance is missing, which can lead to a correspondingly reduced performance of the braking system 1, wherein the driver immediately notices the loss of braking force assistance.

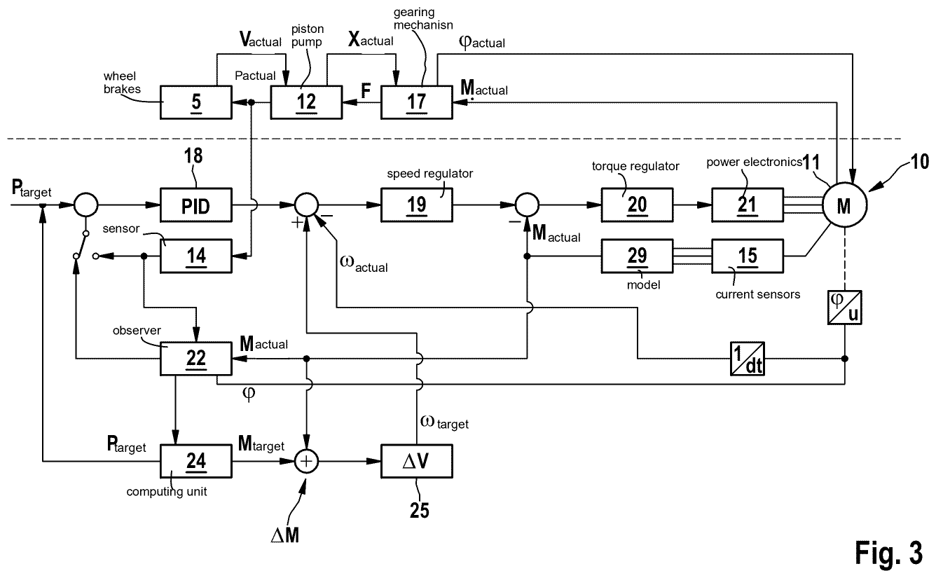

In contrast, the method now advantageously carried out by the control unit 16 ensures that advantageous braking force assistance continues to be ensured even in the event of a malfunction of the sensor 14. FIGS. 2 and 3 each show, in a simplified manner, the method described below:

FIG. 2 shows a simplified flowchart and FIG. 3 shows a more detailed representation. FIG. 3 shows a dashed dividing line, with the physical properties of the system above the dividing line and the advantageous method in a kind of circuit diagram below the dividing line.

When the driver actuates the actuating element 6, the target pressure p_{target} is calculated, depending on which the pressure-generating device 10 is controlled. The control unit 16 in particular calculates the volume flow V_{target} necessary to achieve the target pressure p_{target} in the brake circuits 3, 4 by means of the pressure-generating device 10. Preferably, a pressure regulator 18, which consists of an open-loop controller and a closed-loop controller, is present in the control unit 16. The open-loop controller preferably controls the volume flow V_{target} depending on a PV curve or pressure-volume curve, or one or more stiffness curves for the wheel brakes and the unit itself, which stiffness curves form the basis of the braking system. Depending on the target pressure p_{target} resulting from the braking force request, the desired volume flow is ascertained directly by means of the PV curve. The electric motor 11 or its power electronics 21 is then controlled by means of a speed regulator 19 and a torque regulator 20 in order to implement the target pressure p_{target}.

However, since the braking system 1 can also be subject to disturbance factors, such as leakage, gas inclusions in the brake lines or temperature-dependent viscosity changes of the brake fluid, the closed-loop controller is additionally provided, which ascertains, in particular by means of a control loop and a PID controller, a deviation of the actual pressure p_{actual} in the braking system from the target pressure p_{target}, and, on the basis of this pressure difference, corrects or adjusts the control of the pressure-generating device 10 so that the actual pressure corresponds as closely as possible to the target pressure.

The hydraulic pressure p_{actual} detected by the sensor 14 results, as shown in FIG. 3, from the volume V_{actual} displaced by the piston pump 12, which volume results from the piston area A of the piston and the distance x_{actual} the piston is displaced. The distance x results from the force F_{actual} acting on the piston. The force F_{actual} results from the revolution φ_{actual} of the electric motor 11 and the gear ratio of the gearing mechanism 17.

If the information about the actual pressure p_{actual} usually provided by the pressure sensor 14 is absent, for example due to a malfunction of the sensor 14, a corresponding adjustment or correction is no longer possible.

In the present case, it is provided that the mechanical fallback level is avoided and that braking force assistance is still maintained, at least for a specified period of time. This leaves the driver with improved pedal feel and improved braking performance of the braking system 1. For this purpose, the control unit 16 calculates, by means of an observer 22, replacement information, by which the values or the value of the sensor 14 are to be replaced, and a target pressure p_{target} is provided, which is then taken into account instead of the sensor value of the sensor device 14.

For this purpose, the values of at least one other sensor present in the braking system, in particular a plurality of sensors, such as in particular one or more current sensors 15, are taken into account. The current sensors 15 in particular detect the current iU, iV, iW of the individual phases of a winding of the electric motor 11. Preferably, an actual torque M_{actual} of the electric motor 11 is also ascertained or calculated from the recorded current values by means of a model 29 of the electric motor 11.

In addition, the efficiency of the pressure-generating device 10, in particular of the gearing mechanism 17 connecting the electric motor 11 to the piston pump 12, is taken into account. The efficiency of the gearing mechanism 17 is of great importance for the conversion of the torque of the electric motor into the hydraulic pressure that can be provided by the hydraulic piston of the piston pump. By means of the advantageous method, the efficiency of at least the gearing mechanism 17 is taken into account in the calculation of the replacement information in the event of an absence of the pressure sensor information.

According to FIG. 1, the braking system 1 is put into operation in a step S1. In a subsequent step S2, the working order of the braking system 1 and in particular of the pressure sensor 14 is monitored. If the pressure sensor 14 is working properly and pressure sensor information is available, the braking system 1 continues to operate as a brake-by-wire system as usual in a step S3. However, an efficiency value of the pressure-generating device 10 is continuously ascertained and monitored by means of the observer 22 and, in particular, stored at regular intervals by the control unit 16 in a step S4. The efficiency value is in particular determined depending on the current braking request, the current actual pressure provided in the braking system 1 by the pressure-generating device 10 and the current temperature of the pressure-generating device 10, an age of at least the pressure-generating device, the gear ratio, a gear mechanism hysteresis of the gearing mechanism 17 and/or the direction of movement of the piston or of the electric motor 11. In particular, the efficiency value results from the deviation of the actual pressure from the target pressure specified by the braking force request.

The torque M_{actual} of the electric motor 11, which is ascertained from the phase currents by means of the sensors 15, is proportional to the load acting on the electric motor 11, which load corresponds to the actual pressure in each brake circuit 3, 4. As replacement information, the hydraulic pressure in the brake circuit is therefore preferably estimated depending on the actual torque M_{actual} of the electric motor 11. If the actual torque M_{actual} of the electric motor 11 is known, the hydraulic pressure p_{actual} is preferably estimated depending on the effective area A of the hydraulic piston of the piston pump 12, the ascertained efficiency value and the gear ratio as follows:

$${P}_{actual} = \frac{{M}_{actual} * efficiency value * gear ratio}{A}$$

It follows that a target torque M_{target}, which corresponds to the target hydraulic pressure p_{target}, can be determined depending on the target pressure acting on the pressure piston, the effective area A of the pressure piston, the gear ratio of the gearing mechanism and the aforementioned efficiency value:

$${M}_{target} = \frac{{p}_{target} * A}{gear ratio * efficiency value}$$

The target torque M_{target} is preferably ascertained by means of a computing unit 24, which also determines the target pressure p_{target} for the observer 22.

A torque deviation ΔM results from the target torque M_{target} and the actual torque M_{actual}, as well as a volume correction ΔV, which results from the torque deviation and a boost factor f of boosting 25 by the electric motor 11:

$$Δ M = target torque - actual torque$$

$$Δ V = Δ M * f$$

Preferably, a target rotational speed @target of the electric motor 11 is calculated from the volume correction and is taken into account by the speed regulator in addition to the actual rotational speed ω_{actual}. A correction of the working speed ω of the electric motor 11 or of the pressure piston pump is preferably determined by a PID control loop so that the brake pressure as a whole can be regulated without the pressure sensor 14.

According to an alternative method, an estimated pressure p_{schätz} is ascertained by means of the ascertained efficiency value and the detected direction of movement of the electric motor 11 and thus also of the gearing mechanism 17, which estimated pressure is used instead of the measured actual pressure p_{actual} for the regulation of the target pressure p_{target} in the event of a fault. In this case, the devices 24 and 25 may be omitted.

The accuracy of the calculated pressure depends to a large extent on how close the actual gearing mechanism efficiency is to the estimated value. Since the gearing mechanism efficiency may change depending on the aforementioned parameters, it is ascertained and stored during ongoing operation, as described above. Since the stored efficiency value depending on the operating situation is only usable for a short period of time due to rapidly changing parameters, it is preferably provided that an efficiency value once stored is used for a maximum of 10 or 15 braking operations after the failure of the sensor 14. The use of the efficiency value can also be limited by a specified period of time. When the period of time has elapsed or the permissible braking operations have occurred, the braking system 1 is then preferably switched to the mechanical fallback level.

Preferably, the efficiency value is ascertained and stored with each braking operation. If it is determined in step S2 that the sensor information is no longer available (n), in a subsequent step S5, the efficiency value stored in step S4, in particular the last-stored efficiency value, is used and the hydraulic pressure is estimated as described above in order to carry out the control of the pressure-generating device 10 depending on the estimated hydraulic pressure as replacement information.

In order to ensure that no pressure is maintained in the system when the driver releases or no longer actuates the actuating element 6, it is preferably provided that the hydraulic piston of the piston pump is retracted so far when the actuating element 6 is released that, for example, a pressure relief bore in the hydraulic cylinder can be passed over by the pressure piston and hydraulic medium can thereby escape in order to reduce any remaining hydraulic pressure. Alternatively or additionally, outlet valves of the wheel brakes 5 or changeover or separating valves 9 of the braking system 1 are preferably opened, which make pressure relief possible.

What is claimed is:

1. A method for operating a braking system for a motor vehicle, the braking system including at least one hydraulically actuatable wheel brake, at least one controllable pressure-generating device configured to provide a hydraulic pressure in a brake circuit including the at least one wheel brake, and at least one actuating element that is actuatable by a driver and is configured to specify a braking request, wherein the brake circuit is assigned at least one sensor configured to detect an actual hydraulic pressure in the brake circuit, the method comprising the following steps:
controlling the pressure-generating device is controlled depending on the braking request and the actual hydraulic pressure detected in the brake circuit by the sensor;
ascertaining and storing an efficiency value of the pressure-generating device is ascertained and stored depending on the braking request and the detected actual pressure; and
when there is a function error of the sensor, controlling the pressure-generating device at least depending on the braking request and the stored efficiency value.

2. The method according to claim 1, wherein the efficiency value is recorded and stored regularly, at specified intervals or with each braking request.

3. The method according to claim 1, wherein the pressure-generating device includes a controllable electric motor and a piston pump that is drivable by the electric motor and is configured to generate hydraulic pressure, wherein the electric motor is coupled to the piston pump by a gearing mechanism, and an efficiency value of the gearing mechanism is ascertained as the efficiency value.

4. The method according to claim 3, wherein a current pressure value in the brake circuit is estimated depending on an actual torque of the electric motor and an effective hydraulic area of the piston pump and the efficiency value.

5. The method according to claim 4, wherein the pressure value is estimated depending on a gear ratio of the gearing mechanism of the pressure-generating device and a direction of movement of the electric motor.

6. The method according to claim 4, wherein the pressure-generating device is controlled depending on the estimated pressure value.

7. The method according to claim 4, wherein the estimated pressure value is compared to the pressure value detected by the pressure sensor, to ascertain the efficiency value.

8. The method according to claim 3, wherein, depending on the braking request, a target torque depending on the efficiency value, and depending on the estimated pressure value, is specified to the electric motor.

9. A control unit configured to operate a braking system, the the braking system including at least one hydraulically actuatable wheel brake, at least one controllable pressure-generating device configured to provide a hydraulic pressure in a brake circuit including the at least one wheel brake, and at least one actuating element that is actuatable by a user and is configured to specify a braking request, wherein the brake circuit is assigned at least one sensor configured to detect an actual hydraulic pressure in the brake circuit, and the control unit is configured to:
control the pressure-generating device is controlled depending on the braking request and the actual hydraulic pressure detected in the brake circuit by the sensor;
ascertain and storing an efficiency value of the pressure-generating device is ascertained and stored depending on the braking request and the detected actual pressure; and
when there is a function error of the sensor, control the pressure-generating device at least depending on the braking request and the stored efficiency value.

10. A braking system for a motor vehicle, comprising:
at least one hydraulically actuatable wheel brake;
at least one controllable pressure-generating device configured to provide a hydraulic pressure in a brake circuit including the at least one wheel brake;
at least one actuating element that is actuatable by a driver and is configured to specify a braking request;
wherein the brake circuit is assigned at least one sensor configured to detect an actual hydraulic pressure in the brake circuit; and
a control unit configured to:
control the pressure-generating device is controlled depending on the braking request and the actual hydraulic pressure detected in the brake circuit by the sensor;
ascertain and storing an efficiency value of the pressure-generating device is ascertained and stored depending on the braking request and the detected actual pressure; and
when there is a function error of the sensor, control the pressure-generating device at least depending on the braking request and the stored efficiency value.
